(19) United States
(12) Patent Application Publication
(10) Pub. No.: US 2005/0231463 A1
(43) Pub. Date: Oct. 20, 2005

(54) Input device with multi-directional scrolling wheel

(75) Inventor: Bo-Qing Yang, Taipei (TW)

Correspondence Address: BACON & THOMAS, PLLC, 625 SLATERS LANE, FOURTH FLOOR, ALEXANDRIA, VA, 22314, US

(73) Assignee: KYE SYSTEMS CORP., TAIPEI (TW)

(21) Appl. No.: 10/826,382

(22) Filed: Apr. 19, 2004

(51) Int. Cl. G09G 5/00

(52) U.S. Cl. 345/156

(57) ABSTRACT

A multi-directional scrolling wheel for an input device includes a housing and a carrier supported within the housing. The carrier has a wheel can be rotated freely so as to scroll an image on a display in a Y-axis direction. The carrier can be tilted left and right so as to scroll the image on the display in an X-axis direction.

### BACKGROUND OF THE INVENTION

1. Field of the Invention

The present invention relates to an input device, and in particular, to an input device with a multi-directional scrolling wheel for scrolling an image on a display of a computer.

2. Description of the Prior Art

With the enormous advancement of electronic technology, computers have become indispensable tools for dealing with our daily work, life, and entertainment. Peripheral devices, such a computer mouse, keyboard, trackball, or game controller, are the main accessories for accessing computers. Most peripheral devices have a scrolling wheel to scroll an image on a display.

The best known related skill for scrolling images in WINDOWS™ applications is disclosed in U.S. Pat. No. 5,530,455, which describes a roller on the top of the mouse for vertically scrolling the content of a WINDOWS™ application. If a user wishes to scroll the content horizontally, the user has to additionally press the “Shift” key on a keyboard and then rotate the roller to scroll the content horizontally. If the user is willing to spend still more energy to move the cursor to the horizontal scrolling bar and rotate the roller or drag the scrolling bar, then the user can also scroll the image horizontally.

In order overcome the defect of requiring extra effort on the part of the user to scroll horizontally, U.S. Published Patent Application No. 20030025673 discloses a wheel assembly which can be rotated for scrolling the image vertically (in an x-axis direction), or tilted for scrolling the image horizontally (in a y-axis direction). However, an extra optical encoder must be positioned within the wheel assembly so as to detect the rotation of the wheel and scroll the image in the y-axis direction. The complex structure of the wheel assembly disclosed in the patent publication will no doubt to highly cause a costly product, not only because of the need for precisely produced components, but also because of the difficulty in assembling the numerous components of the wheel.

### SUMMARY OF THE INVENTION

It is an object of the present invention to provide an efficient and easy-to-assemble wheel assembly for controlling scrolling of the image both in an x-axis and a y-axis direction, and in particular a wheel assembly in which it is not necessary to position and extra optical encoder within the wheel assembly in order to detect rotation of the wheel and scroll the image in the y-axis direction. This objective is accomplished, according to the principles of various preferred embodiments of the invention, by rotatably mounting the wheel on a first axle within a carrier that is itself pivotally mounted on a second extended axle, and coupling encoders to each of the axles for detecting their respective rotations, thereby enabling the encoders to be positioned in a simplified manner outside the wheel and carrier assembly.

### BRIEF DESCRIPTION OF THE DRAWINGS

FIG. 1 is a perspective view of the present invention connected with a computer.

FIG. 2 is a perspective view of the present invention applied in a computer mouse.

FIG. 3 is an exploded view of the first embodiment according to the present invention.

FIG. 4A-4B are two perspective views of the first embodiment according to the present invention.

FIG. 5A is an exploded view of the wheel assembly according to the present invention.

FIG. 5B˜5C are sectional views of the wheel assembly showing tilting of the wheel.

FIG. 6 is a lateral view of a second embodiment according to the present invention.

FIG. 7A-7B are two perspective views of a third embodiment according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

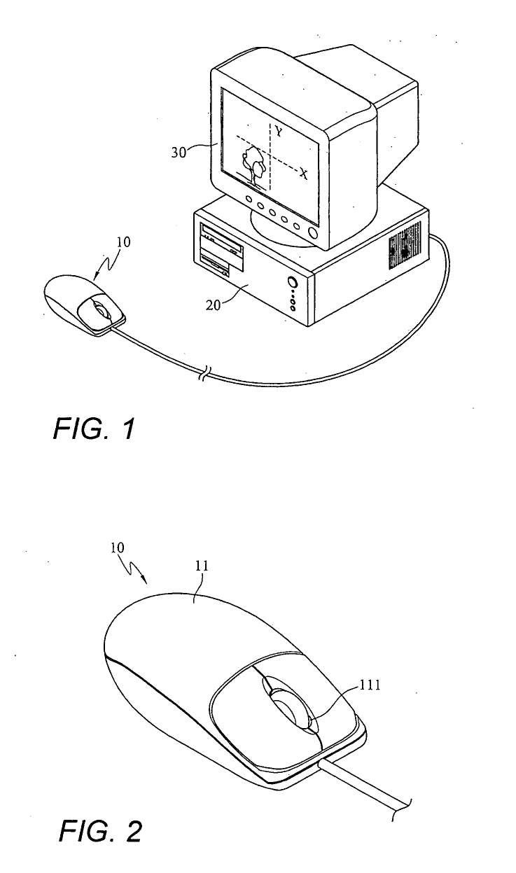

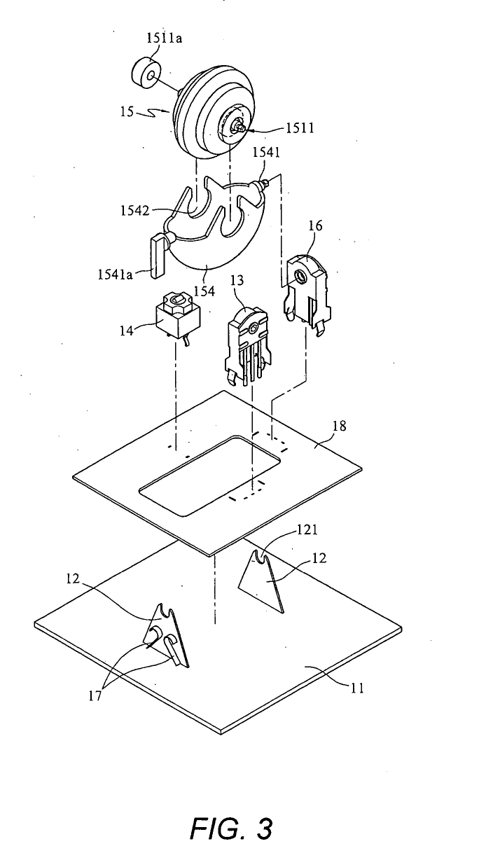

Referring to FIGS. 1˜3, an input device 10 is connected to a computer 20. The input device 10 can be a mouse, trackball, tablet, game controller, etc. A user can rotate the wheel assembly 15 to scroll the image on the display 30 in a Y-axis direction, and the Wheel assembly 15 can be further tilted to scroll the image in the X-axis direction. A slot or opening 111 is provided on the top of the housing 11, enabling a portion of the wheel assembly 15 to protrude therefrom.

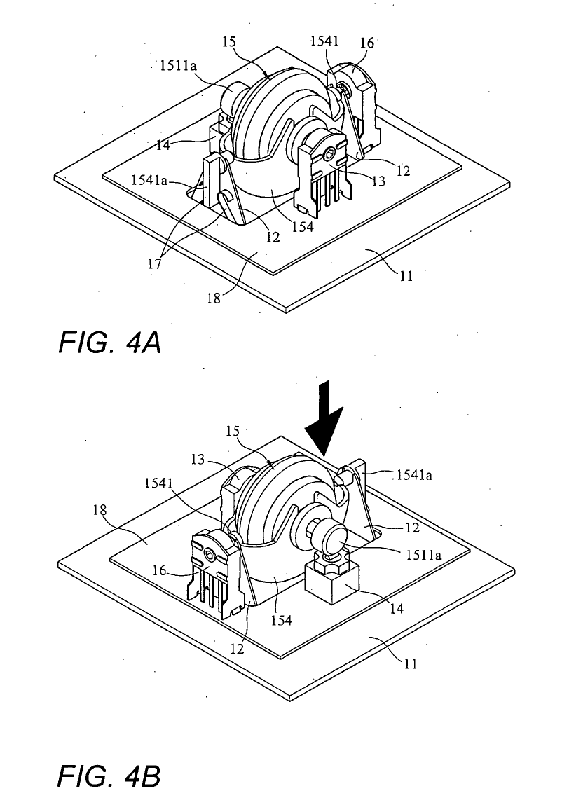

Referring to FIGS. 3˜4B, the input device 10 includes a printed circuit board (PCB) 18, two supports 12, a first encoder 16, a second encoder 13, a micro switch 14, and a wheel assembly 15. The PCB 18 is located within the housing 11, and both of the supports 12 penetrate the opening of the PCB 18. The first and second encoders 16,13 are separately positioned on the PCB. The wheel assembly 15 includes an axle 1511, and is supported in a carrier 154 by holes 1542 that allow the wheel assembly 15 to be rotated with respect to the carrier. The carrier 154 also has front and rear extended axles 1541 supported by the supports 12 that allow the wheel assembly 15 to be tilted independently around an axis perpendicular to axle 1511.

One end of axle 1511 is coupled to the second encoder 13, and the other end of axle 1511 has a pressing portion 1511a for engaging micro switch 14 located thereunder. The front extended axle 1541 is coupled to the first encoder 16, and the rear extended axle 1541 has a positioning portion 1541a which is retained by a retaining unit 17. The retaining unit 17 can be made of steel, plastic, or any other resilient material and functions like a spring to push the positioning element 17 towards and initial or center non-tilted position.

When a user rotates the wheel assembly 15 forwards or backwards, the second encoder 13 can detect the angle and rotation direction of the axle 1511 so as to scroll the image up and down in the Y-axis direction. In addition, when the user presses down on the wheel assembly 15, the axle 1511 will pivot with respect to the second encoder 13 and move in the holes 1542 so as to activate the micro switch 14, such that an extra function or command can be further utilized, such as power scrolling, logging onto the internet . . . etc.

Due to the positioning of the retaining units 17 relative to the positioning portion 1541a, the whole carrier 154 is biased towards the center non-tilted position, and remains in that position until a tilting force is applied by the user. When the user tilts the wheel assembly 15 left or right, the carrier 154 will pivot with respect to the axle 1541 and the first encoder 16 can detect the angle and rotation direction of the axle 1541, which results from the tilting movement, so as to scroll the image left and right in the X-axis direction. When the user releases the force from the wheel assembly 15, the retaining unit 17 will push the positioning portion 1541a back to the center, non-tilted position.

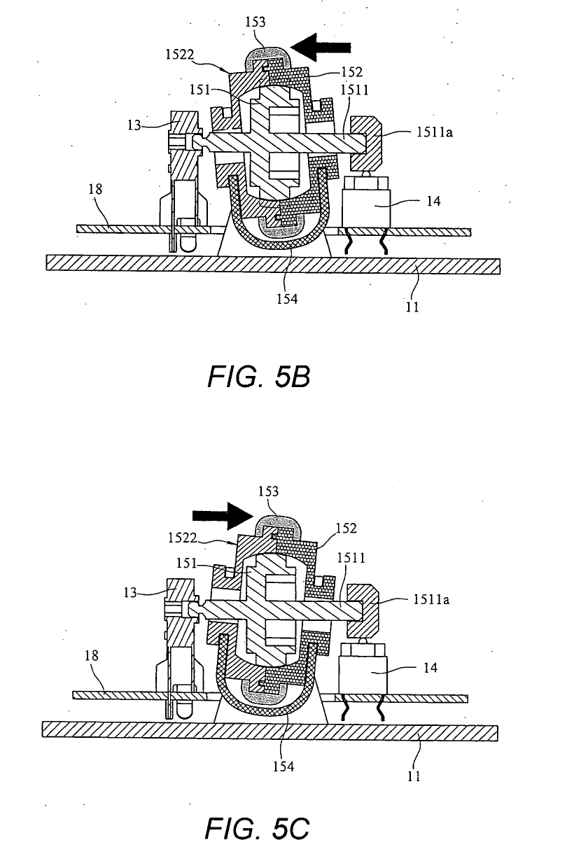

Referring to FIG. 5A, the wheel assembly 15 has an inner wheel 151, an outer wheel 152, a sheath 153 and a carrier 154. The sheath 153 is usually made of materials with larger friction to facilitate rotation of the wheel assembly 15 by the user. The inner wheel 151 has several recesses 1512 on its periphery. Furthermore, the outer wheel 152 consists of two halves of a sphere 1522 combined together in any known manner. Each half of sphere 1522 has several protrusions 1521 extending from the inner face, which correspond to the recesses 1512 respectively. Therefore, when the user rotates the sheath 153, the outer wheel 152 will be forced to rotate the inner wheel 153 together.

Please refer to FIGS. 5B and 5C. When the user tilts the sheath 153 left or right, the protrusion 1521 will be forced to move within the recess 1512 such that the outer wheel 152 will tilt on the outside of the inner wheel 151. In other words, the inner wheel 151 and axle 1511 will stand still while the outer wheel 152 tilts. Because the outer wheel is directly coupled to and carried by the carrier 154, if the user tilts the sheath 153, the outer wheel 152 will be moved together with the carrier 154 that is pivotally connected to the extended axle 1541. Therefore, when the wheel assembly is tilted, the first encoder 16 can translate the resulting angle and rotation direction of the axle 1541 so as to scroll the image left and right in the X-axis direction.

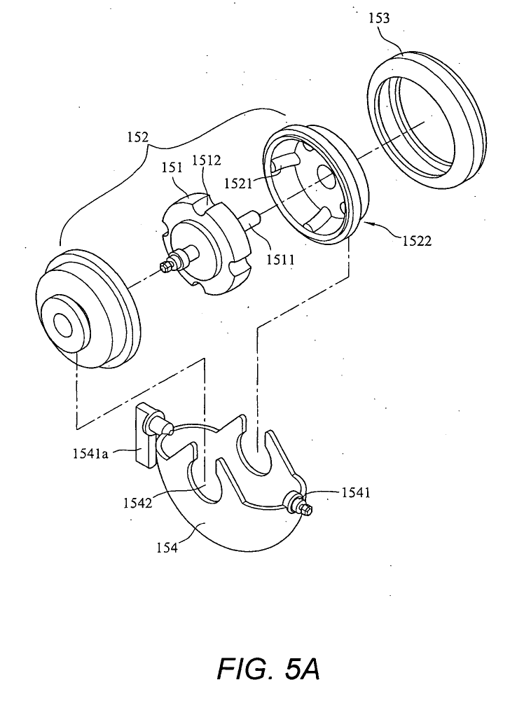

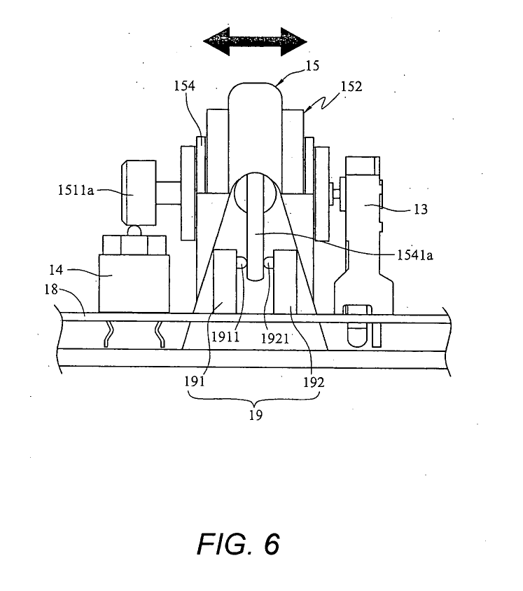

FIG. 6 shows the second embodiment of the present invention. The second embodiment is essentially similar to the first embodiment shown in FIG. 4A. In the second embodiment, the first encoder 16 and retaining units 17 have been removed from the PCB 18, and the positioning portion 1541a placed between two micro switches 191, 192 instead. When the user tilts the wheel assembly 15 to the left (or right), the positioning portion 1541a will be forced to the right (or left) so as to activate the micro switch 192 (191) via activating portion 1921 (1911), at which time the angle and direction of rotation of the axle 1541 can be detected so as to scroll the image left and right in the x-axis direction. When the user releases the force from the wheel assembly 15, a corresponding activating portion 1921 (or 1911 ) will push the positioning portion 1541 a back to the constant position.

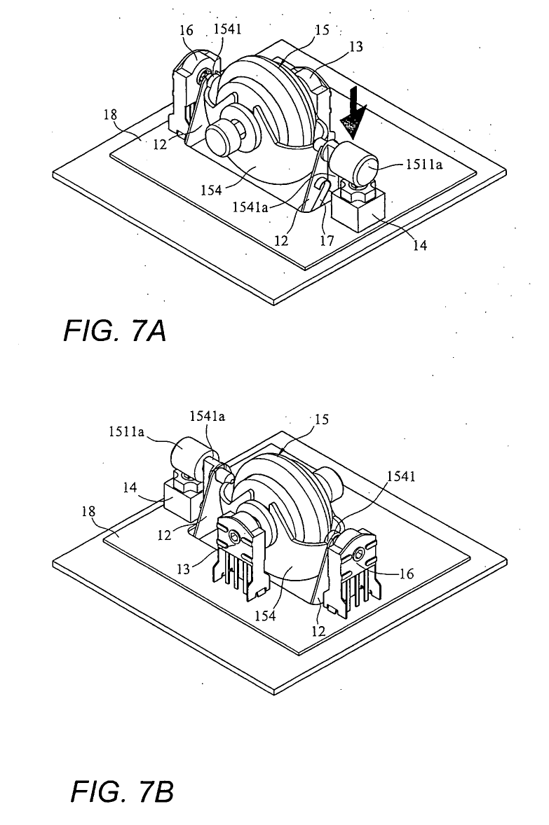

FIGS. 7A and 7B are different perspective views of a third embodiment according to the present invention. The third embodiment is mainly similar to the first embodiment shown in FIG. 4A. In the third embodiment, the pressing portion 1511a is coupled to the rear extended axle 1541 next to the positioning portion 1541a, and the micro switch 14 is moved alone the rear extended axle 1541 and beneath the pressing portion 1511a. When a user rotates the wheel assembly 15 forwards or backwards, the second encoder 13 still can translate the amount and the direction of the axle 1511 so as to scroll the image up and down in Y-axle direction. In addition, when the user presses down the wheel assembly 15, the front and rear extended axles 1541 will pivot with respect to the first encoder 16 and move in the holes 121 of the supports 12 so as to activate the micro switch 14 by the pressing portion 1511a. Therefore, an extra function or command can be further utilized. However, when the user tilts the wheel assembly 15 left or right, the carrier 154 will rotate the axle 1541 and the first encoder 16 can detect the angle and rotation direction of the axle 1541 so as to scroll the image left and right in the X-axis direction. When the user releases the force from the wheel assembly 15, the retaining unit 17 will push the positioning portion 1541a back to the initial position.

While the description above refers to particular embodiments of the present invention, it will be understood that many modifications may be made without departing from the spirit thereof. The accompanying claims are intended to cover such modifications as would fall within the true scope and spirit of the present invention.

1. An input device with a multi-directional scrolling wheel, comprising:
a housing;
a carrier pivotally supported within the housing;
a wheel with a first axle rotatably supported within the carrier;
an extended axle for pivotally mounting the carrier;
a device for detecting rotation of the extended axle in response to tilting of the carrier; and
a second device for detecting rotation of the first axle;
wherein the wheel is arranged to be freely rotated so as to scroll an image in a Y-axis direction,
wherein the carrier is arranged to be tilted left and right so as to scroll the image in an X-axis direction, and
wherein the second device is an encoder coupled to the first axle and positioned outside the carrier.

2. The input device as claimed in claim 1, wherein the first device is a first encoder coupled to the extended axle and located outside of the carrier for detecting rotation of the extended axle that results from tilting of the carrier.

3. The input device as claimed in claim 2, wherein the first device is a potentiometer.

4. The input device as claimed in claim 1, wherein the second device is a potentiometer.

5. The input device as claimed in claim 1, wherein the extended axle of the carrier is perpendicular to the axle of the wheel.

6. The input device as claimed in claim 1, wherein the extended axle is arranged to activate a microswitch positioned below the extended axle when the wheel is pressed in a vertical direction to cause corresponding vertical movement of the extended axle.

7. The input device as claimed in claim 1, wherein the first device includes microswitches positioned on opposite sides of a downwardly extending portion of the extended axle, said microswitches being arranged to detect rotation of the extended axle resulting from tilting of the wheel.

8. The input device as claimed in claim 1, wherein a retaining unit is located within the housing to maintain the carrier in a non-tilted position.

9. The input device as claimed in claim 8, wherein the retaining unit is made of a flexible material.

10. The input device as claimed in claim 1, wherein the first axle is arranged to activate a micro switch located outside of the carrier when the wheel is pressed in a downward direction.

11. The input device as claimed in claim 1, wherein the wheel has an inner wheel and an outer wheel; and the outer wheel is arranged to tilt relative to the inner wheel in order to tilt the carrier, a resulting movement of the extended axle being detected to cause said scrolling in the X-axis direction.

12. The input device as claimed in claim 11, wherein a periphery of inner wheel at least has a first retaining portion, and a periphery of the outer wheel correspondingly has at least a second retaining portion; the first retaining portion allowing a tilting movement of the second retaining portion.

13. The input device as claimed in claim 12, wherein the first retaining portion is a recess, and the second retaining portion is a protrusion.
